(19) United States
(12) Patent Application Publication
(10) Pub. No.: US 2018/0263411 A1
(43) Pub. Date: Sep. 20, 2018

(54) DETACHABLE POLYMERIC DUTCH OVEN LINER

(71) Applicants: Kevin Stuart, Stansbury Park, UT (US); James Stewart, Lehi, UT (US)

(72) Inventors: Kevin Stuart, Stansbury Park, UT (US); James Stewart, Lehi, UT (US)

(21) Appl. No.: 15/463,488

(22) Filed: Mar. 20, 2017

(51) Int. Cl. A47J 36/16; A47J 36/04; B65D 25/04

(52) U.S. Cl. CPC A47J 36/16; B65D 25/04; A47J 36/04

(57) ABSTRACT

An detachable, flexible, polymeric Dutch oven liner for insulating perishables and uniformly distributing heat from an enclosing Dutch oven, the liner comprising a planar bottom surface and uninterrupted circumscribing sidewall contoured to mate with an interior surface of the Dutch oven.

### BACKGROUND OF THE INVENTION

### Field of the Invention

This invention relates to outdoor cooking products and more particularly to a Dutch oven cooking accessory.

### Description of the Related Art

Dutch ovens are well-known in the prior art, as are methods of cooking using Dutch ovens in connection with a charcoal or wood heating source. Dutch oven covers and charcoal briquettes have long been used to heat Dutch ovens and protect various components of the oven. Because these briquettes are usually predominantly disposed beneath the Dutch oven, heat is not typically uniformly distributed about the exterior of the cast iron ovens, often causing burning of the perishables within the Dutch oven disposed in closer proximity to the bottom interior surface and undercooking of perishables disposed in closer proximity to the cover (or top surface). It can be difficult to clean Dutch ovens, which are cumbersome and not easily used in dishwashers of standard sizes and cleaning Dutch ovens for on site reuse in outdoor settings where modern cleaning apparati are not available also frequently presents sanitation problems.

There exist no apparati, systems or methods in the art to prevent burning and sticking of perishables to the bottom surface of a Dutch oven or which help facilitate uniform distribution of heat throughout the interior of the oven and/or insulate perishable from the bottom surface. There exist no apparati or method of preventing grease, soot and burned perishable material from caking and/or adhering to the interior bottom and side surfaces of the grill.

Beneficially, a product which overcomes these inefficiencies would be disposable, reusable and easily cleaned. Beneficially, such a product would protect the bottom and sides of the interior of the grill from dirt, grease and the like so as to maintain the cleanliness of the interior body of the grill. Beneficially, such a product would be easily insertable in and out of a Dutch oven while the Dutch oven is hot without burning a user.

No apparati or methods which have heretofore been designed cure these inefficiencies. As a result, there is a need for a Dutch oven liner provided below. In summary, the lack of adequate solutions to the above-mentioned problems remain unsolved.

### SUMMARY OF THE INVENTION

From the foregoing discussion, it should be apparent that a need exists for a detachable polymeric Dutch oven liner. Beneficially, such an apparatus would overcome many of the difficulties and concerns expressed above, by providing a flexible, lightweight, easily cleanable and insulating product.

The present invention has been developed in response to the problems and needs in the art that have not yet been fully solved by currently available apparati and methods. Accordingly, the present invention has been developed to provide a detachable, flexible, polymeric Dutch oven liner comprising: a concave polymeric liner having an exterior surface shaped to contour an interior surface of a Dutch oven, the polymeric liner comprising: a circular planar bottom surface; a seamless, uninterrupted, upwardly-rising sidewall circumscribing the bottom surface; and an uninterrupted annular flange circumscribing a top edge of the upwardly-rising sidewall.

The polymeric Dutch oven liner may further comprise a plurality of tabs depending from the flange.

The polymeric Dutch oven liner may further comprise a divider affixed to the sidewall defining a plurality of compartments. The polymeric Dutch oven liner may further comprise a plurality of dividers affixed to the sidewall defining a plurality of compartments.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is an environmental top-side perspective view of a detachable polymeric Dutch oven liner and separated Dutch oven in accordance with the present invention;

FIG. 2 is a top-side perspective view of a Dutch oven and enclosed detachable polymeric Dutch oven liner in accordance with the present invention;

FIG. 3 is a top-side perspective view of a detachable polymeric Dutch oven liner in accordance with the present invention;

FIG. 4 is a top perspective view of a detachable polymeric Dutch oven liner in accordance with the present invention;

FIG. 5 is an environmental bottom-side perspective view of a detachable polymeric Dutch oven liner with tabs and separated Dutch oven in accordance with the present invention;

FIG. 6 is a top-side perspective view of a detachable polymeric Dutch oven liner with tabs in accordance with the present invention;

FIG. 7 is a side perspective view of a detachable polymeric Dutch oven liner with tabs in accordance with the present invention;

FIG. 8 is an environmental bottom-side perspective view of a detachable polymeric Dutch oven liner with tabs and enclosing Dutch oven in accordance with the present invention;

FIG. 9 is a side perspective view of a detachable polymeric Dutch oven liner with tabs in accordance with the present invention; and

FIG. 10 is a top-side perspective view of a detachable polymeric Dutch oven liner with a divider in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

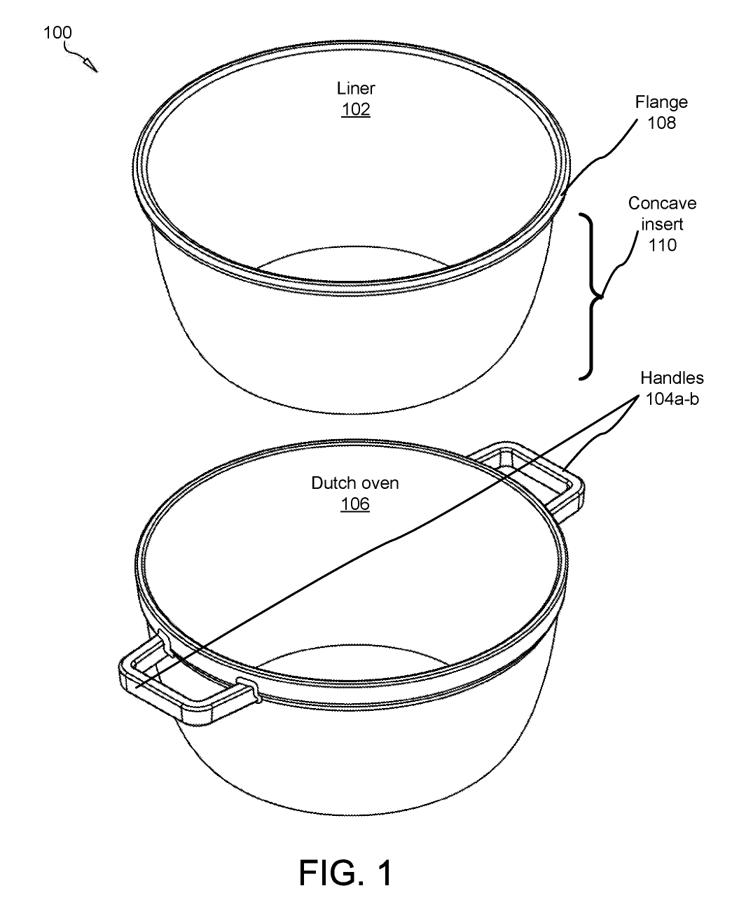

FIG. 1 is an environmental top-side perspective view of a detachable polymeric Dutch oven liner and separated Dutch oven 100 in accordance with the present invention. The apparatus 100 comprises a liner 102 having a flange 112 and a Dutch oven 106 having handles 104a-b.

The liner 102, in the shown embodiment, comprises an inverted frustoconical seamless enclosure with an open top end. In various embodiments, the liner 102 comprises a concave container. The liner 102 is received by, mated with and nested in an interior recess of a Dutch oven 106 having an interior surface which contours the exterior surface of the liner 102. In the preferred embodiment, the liner 102 is fabricated from, and comprises, a flexible, heat-resistant polymeric material. In less-preferred embodiments, the liner 102 comprises an organic material such as wood or leather.

In various embodiments, the liner 102 comprises an uninterrupted annular flange 112, or lip or rim, which circumscribes the top edge of the liner 102. The outer periphery of the of the flange 112 may overlay a top rim of a Dutch oven 106. The Dutch oven 106 typically comprises handles 104a-b as shown.

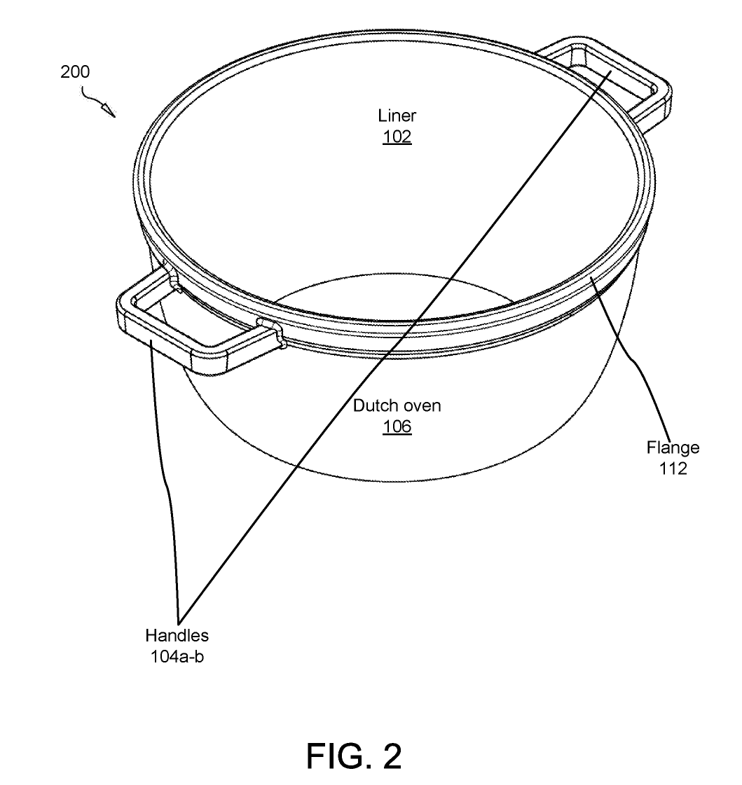

FIG. 2 is a top-side perspective view of a Dutch oven and enclosed detachable polymeric Dutch oven liner 200 in accordance with the present invention.

The liner 102 is disposed interiorly to the Dutch oven 106 with the flange 112 overlaying the top edge of the Dutch oven 106 in some embodiments.

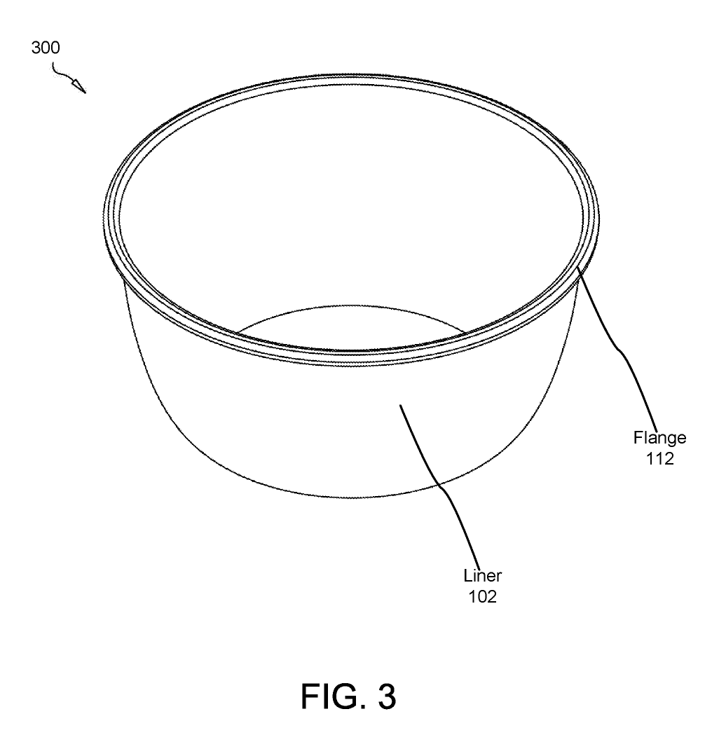

FIG. 3 is a top-side perspective view of a detachable polymeric Dutch oven liner 300 in accordance with the present invention. FIG. 3 shown the liner 102 alone outside of its environment. The flange 112 may comprise a rolled seamless lip.

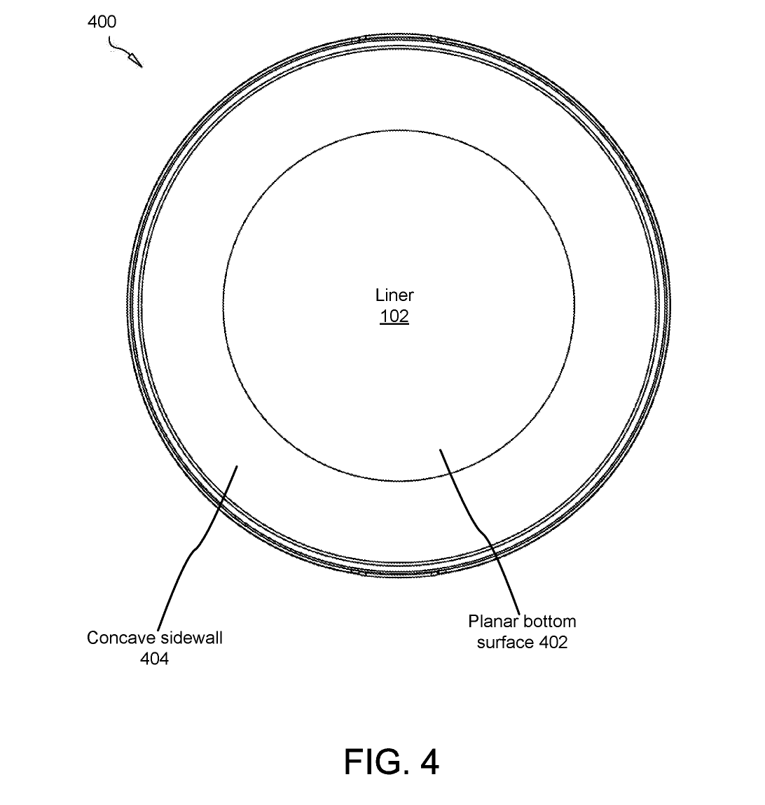

FIG. 4 is a top perspective view of a detachable polymeric Dutch oven liner 400 in accordance with the present invention. The apparatus 400 comprises a planar bottom surface 402 and a concave sidewall 404.

The bottom surface 402 of the liner 102 may be planar and circular or elliptical in shape. The concave sidewall 404 comprises an outwardly bulging, seamless, uninterrupted sidewall which circumscribes the planar bottom surface 402.

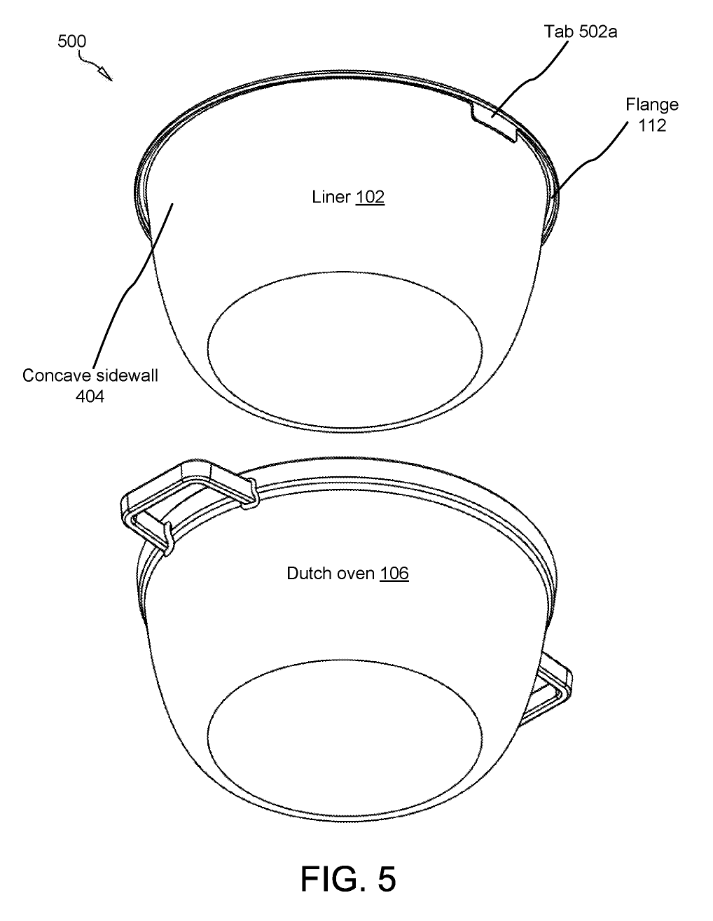

FIG. 5 is an environmental bottom-side perspective view of a detachable polymeric Dutch oven liner with tabs and separated Dutch oven 500 in accordance with the present invention.

The apparatus 500 comprises a liner 102 as previously described but additionally having one or more tabs 502. The tabs 502 are preferably formed as a single integrated piece with the liner 102 or alternatively adhered or heat-pressed onto the liner 102.

The tabs 502 may hang from the flange 112 spaced apart from the concave sidewall 404 such that the tabs hang over a top edge of a Dutch oven 106. The tabs 502 may be rectangular in shape, polygonal in shape, irregularly shaped, or of any other shape sufficient to allow a user to grip them and remove the liner 102 from a heated Dutch oven 106.

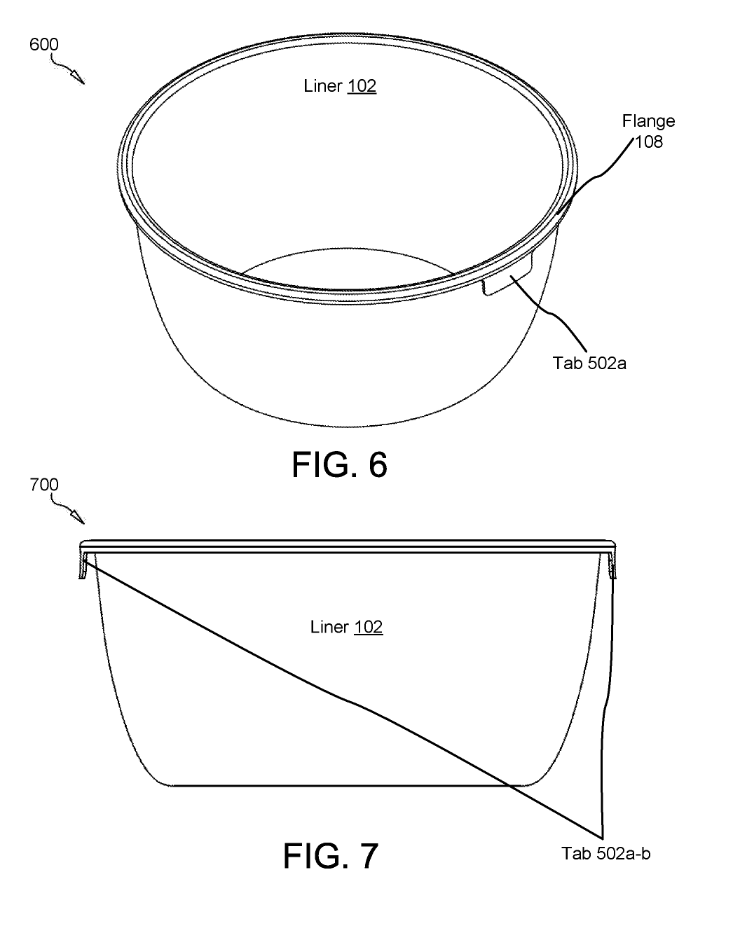

FIG. 6 is a top-side perspective view of a detachable polymeric Dutch oven liner with tabs 600 in accordance with the present invention.

As shown.

FIG. 7 is a side perspective view of a detachable polymeric Dutch oven liner with tabs 700 in accordance with the present invention.

The apparatus 700 shows a side perspective view of the tabs 502a-b.

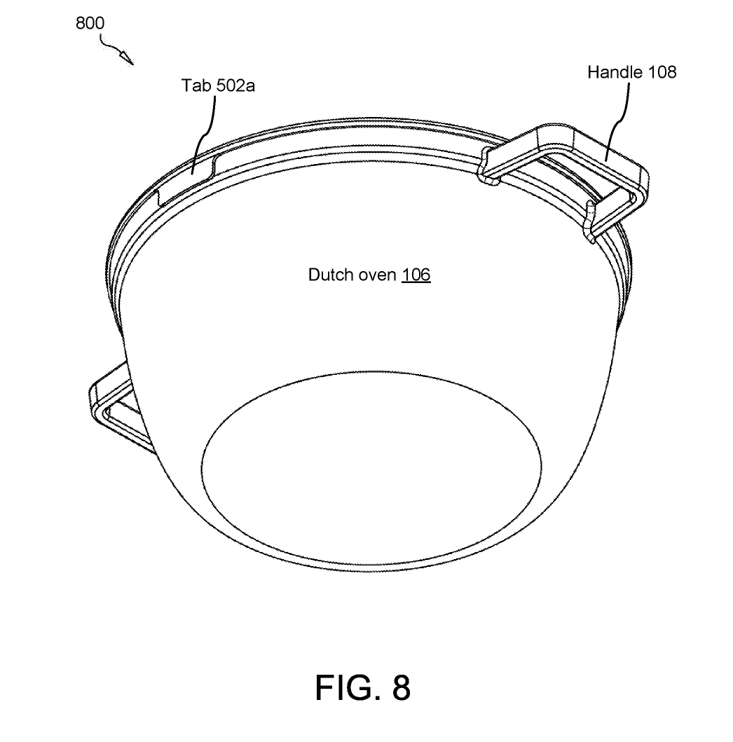

FIG. 8 is an environmental bottom-side perspective view of a detachable polymeric Dutch oven liner with tabs and enclosing Dutch oven 800 in accordance with the present invention.

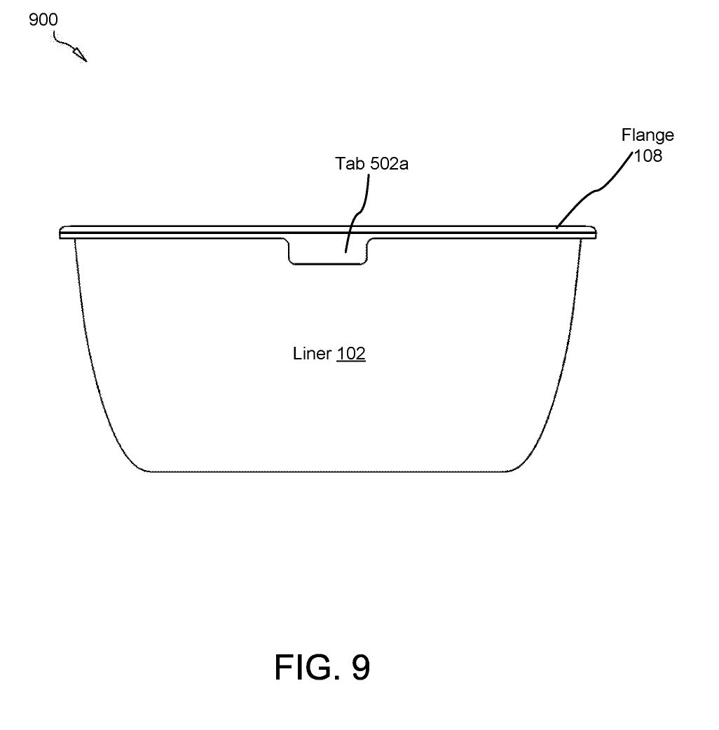

FIG. 9 is a side perspective view of a detachable polymeric Dutch oven liner with tabs 900 in accordance with the present invention.

As shown.

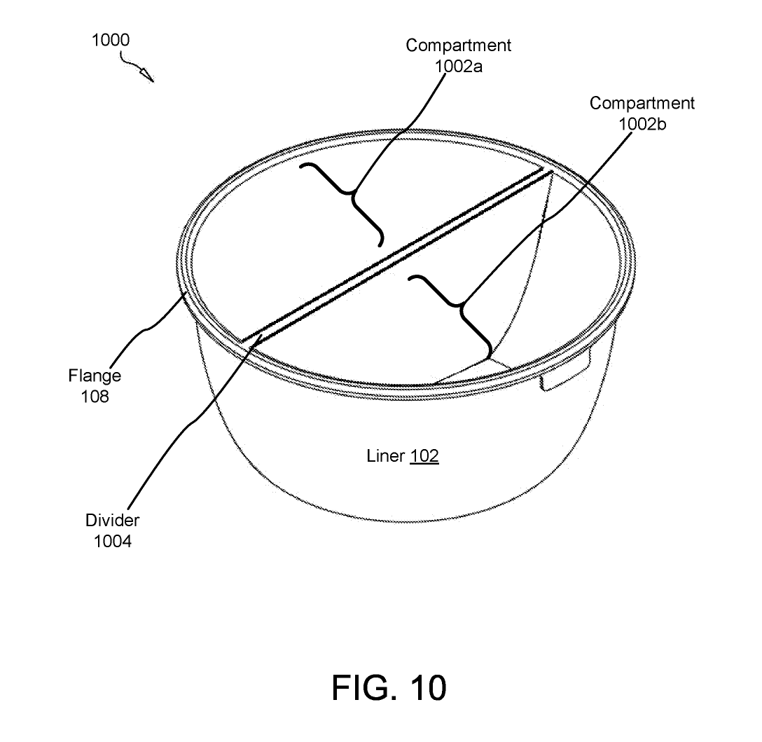

FIG. 10 is a top-side perspective view of a detachable polymeric Dutch oven liner with a divider 1000 in accordance with the present invention.

In various embodiments, the Dutch oven liner may comprise one or more dividers 1004 traversing the interior recess of the liner 1000 between sidewalls 404. The divider together with the sidewall 404 defines a plurality of compartments 1002a-b into which separate perishables or food sources can be cooked at once.

The attached drawing and description provide a modular extruded aluminum assembly. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A detachable, flexible, polymeric Dutch oven liner comprising:
a concave polymeric liner having an exterior surface shaped to contour an interior surface of a Dutch oven, the polymeric liner comprising:
a circular planar bottom surface;
a seamless, uninterrupted, upwardly-rising sidewall circumscribing the bottom surface; and
an uninterrupted annular flange circumscribing a top edge of the upwardly-rising sidewall.

2. The polymeric Dutch oven liner of claim 1, further comprising a plurality of tabs depending from the flange.

3. The polymeric Dutch oven liner of claim 1, further comprising a divider affixed to the sidewall defining a plurality of compartments.

4. The polymeric Dutch oven liner of claim 1, further comprising a plurality of dividers affixed to the sidewall defining a plurality of compartments.
